(19) United States
(12) Patent Application Publication
(10) Pub. No.: US 2003/0165198 A1
(43) Pub. Date: Sep. 4, 2003

(54) MOTION DETECTION METHOD WITH USER-ADJUSTABLE PARAMETERS FOR BETTER DETECTION ACCURACY

(76) Inventors: HSIAO-PING CHEN, Tao-Yuan Hsien (TW); CHENG-LIANG KAO, Tai-Nan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,851

(22) Filed: Feb. 25, 2003

(30) Foreign Application Priority Data
Mar. 1, 2002 (TW) 091103857

(51) Int. Cl. H04N 7/18

(52) U.S. Cl. 375/240.29; 375/240.16

(57) ABSTRACT

A motion detection method based on a detecting system is used to detect a moving object and trigger a corresponding event through a set of consecutive frames. The motion detection method includes comparing duration of the event with a first threshold value for determining whether the event is valid, comparing an interval between two successive events for determining whether the latter of the successive events is combined with the first of the events, and comparing size of the moving object with a predetermined rectangle for determining whether the moving object meets a size limitation of the predetermined rectangle.

### BACKGROUND OF THE INVENTION

1. Field of the Invention

The present invention relates to a motion detection method, and more particularly, to a motion detection method with user-adjustable parameters for better detection accuracy.

2. Description of the Prior Art

Digital video recordings (DVR), which have functions of monitor, video, playing, far-end control, and so on, are popular applications. The digital video recordings use a frame generator to photograph image frames and then store the image frames into a computer after a compression process. Since image compression technology is being developed rapidly, for example, MPEG4 has successfully been used in the digital video recordings, people can use limited hard disc capacity of computers to store the image frames for several weeks or one year. The digital video recordings replace old closed circuit televisions (CCTV). Since the digital video recordings use storage media (such as hard discs) to store the image frames, they do not have problems such as mildew, forgetting to switch to a new video, and difficult management of the videos, as was the case of the closed circuit televisions. Moreover, the image data are digital data, so that the image data can be quickly transmitted to distant places through a network, thereby decreasing the transmission time. People in the distant places can receive the image data fast. In addition, the digital image data can be further processed. For example, the digital video recordings always have a monitor and an alarm, so that the digital video recordings can perform the monitor operation through the digital signal. The digital video recordings determine whether an object is moving according to the computer operation, so as to generate a corresponding warning signal.

A prior art detection method uses a calculating device to compare a plurality of image frames generated by a frame generator so as to determine whether an object is moving inside a scene. The calculating device compares a first image frame with a successive second image frame inside the plurality of image frames so as to determine whether the object is moving inside the scene. In general, when the object is moving, a plurality of pixels inside the image frame generated by the frame generator is changed. Therefore, when comparing the first image frame with the second image frame, the calculating device can use a change of the plurality of pixels inside the first and second image frame to be a judge criterion. That means when the plurality of pixels of the image frame are changed, the calculating device can determine whether something is moving inside the scene according to the first image frame and the second image frame.

Please refer to FIG. 1 and FIG. 2. FIG. 1 is a perspective view of a prior art detecting system 50. FIG. 2 is a block diagram of the prior art detecting system 50. As mentioned above, the detecting system 50 determines whether something is moving inside a scene 52 according to a predetermined detection method. The detecting system 50 comprises a frame generator 20 and a calculating device 30. The frame generator 20 is used to periodically picture the scene 52 according to a predetermined period (30 times per second) to generate a plurality of image frames 22. The calculating device 30 is used to process a first image frame 24 and a second image frame 26 inside the plurality of image frames 22, and compare the first image frame 24 with the second image frame 26 according to the predetermined detecting method so as to determine whether something is moving inside the scene 52. When the calculating device 30 determines whether something is moving inside the scene 52, the calculating device 30 compares each pixel of the second image frame 26 with the corresponding pixel of the first image frame 24 so as to calculate an amount of different pixels between the first and second image frame 24, 26. When the amount of the different pixels is larger than a predetermined value, the detecting system 50 determines that something is moving inside the scene 52, otherwise, the detecting system 50 determines that there is not anything moving inside the scene 52.

However, there are some things that are not important for users even though they are moving. For example, users use the detecting system 50 to detect whether something is moving around a door of a house (scene 52). When a leaf is falling down, the frame generator 20 pictures the falling leaf in order to obtain the plurality of image frames 22. The calculating device 30 compares the plurality of image frames 22. Since the falling leaf makes the pixels of each image frame 22 change, the detecting system 50 determines that an object is moving inside the scene 52 and generates a corresponding warning signal. However, the falling leaf is not important for users, it is unnecessary to process an event corresponding to the falling leaf or to detonate the warning signal. Similarly, when a passerby goes past the door of the house quickly, the detecting system 50 also determines that something is moving inside the scene 52. Therefore, the detecting system 50 always detects events that are not important for users. Users hope that the detecting system 50 can generate a corresponding warning signal when a dubious stranger moves around before the door. However, when a large object (such as a truck) or a small object (such as a mouse) goes pass the door, that means objects are moving inside the scene 52. Then the calculating device 30 compares the successive image frames 22 and the detecting system 50 determines that there are objects moving inside the scene 52, thereby a warning signal is generated. However, the truck or the mouse is not the detecting target (dubious stranger) for users. That means the prior art detecting system 50 is unable to filter the unimportant large object and little object, meaning that the prior art detecting system 50 easily generates an incorrect determination. In addition, the detecting system 50 generates the warning signal only when object is moving inside the scene 52. Therefore, when the dubious stranger is moving before the door of the user, the detecting system 50 records the corresponding image frame 22 and generates the warning signal. However, when the dubious stranger remains motionless, since the detecting system 50 does not detect anything is moving, the detecting system 50 does not record the corresponding image frame 22. When the dubious stranger starts to move again after keeping motionless, the detecting system 50 determines that something is moving inside the scene 52, generates the warning signal, and records the corresponding image frames 22. Although the same object generates the first event and the second event, the detecting system 50 is unable to recognize this, so that the detecting system 50 determines that the two events are generated by different objects. Therefore, the detecting system 50 ignores a period in which the dubious stranger remains motionless. The detecting system 50 does not generate the corresponding warning signal or record the corresponding image frame during the motionless period.

### SUMMARY OF INVENTION

It is therefore a primary objective of the claimed invention to provide a motion detection method that can prevent incorrect detections.

The claimed invention, briefly summarized, discloses a motion detection method with user-adjustable parameters for better detection accuracy. The motion detection method is based on a detecting system for detecting a moving object and triggering a corresponding event through a set of consecutive frames. The motion detection method comprises comparing duration of the event with a first threshold value for determining whether the event is valid, comparing an interval between two successive events for determining whether the latter of the successive events is combined with the first of the events, and comparing size of the moving object with a predetermined rectangle for determining whether the moving object meets a size limitation of the predetermined rectangle.

It is an advantage of the claimed invention that the claimed invention satisfies the detection demands of users and also avoids the incorrect determinations.

These and other objectives of the claimed invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a perspective view of a prior art detecting system.

FIG. 2 is a block diagram of the prior art detecting system.

FIG. 3 is a flow chart of a first embodiment of a present invention motion detection method.

FIG. 4 is a perspective view of the first embodiment of the present invention motion detection method.

FIG. 5 is a flow chart of a second embodiment of the present invention motion detection method.

FIG. 6 is a perspective view of the second embodiment of the present invention motion detection method.

FIG. 7 is a flow chart of a third embodiment of the present invention motion detection method.

FIG. 8 to FIG. 10 are perspective views of the third embodiment of the present invention motion detection method.

### DETAILED DESCRIPTION

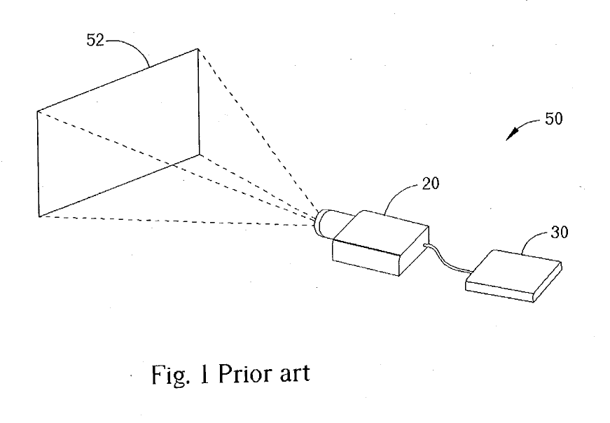

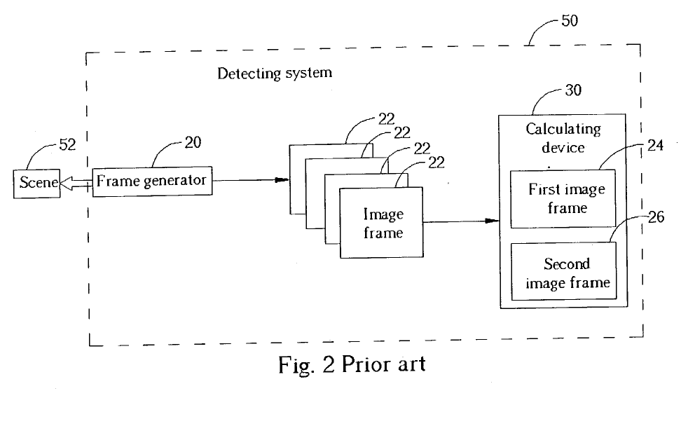

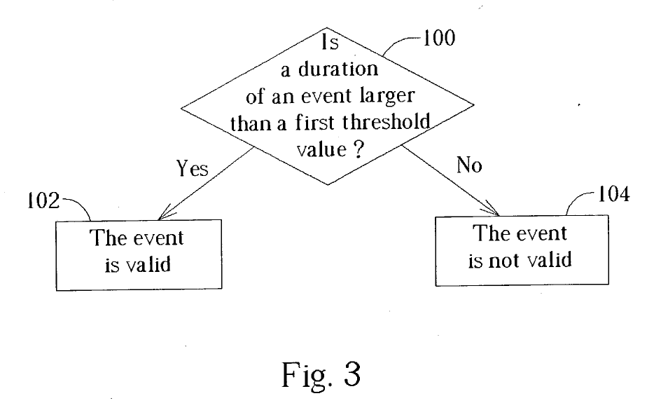

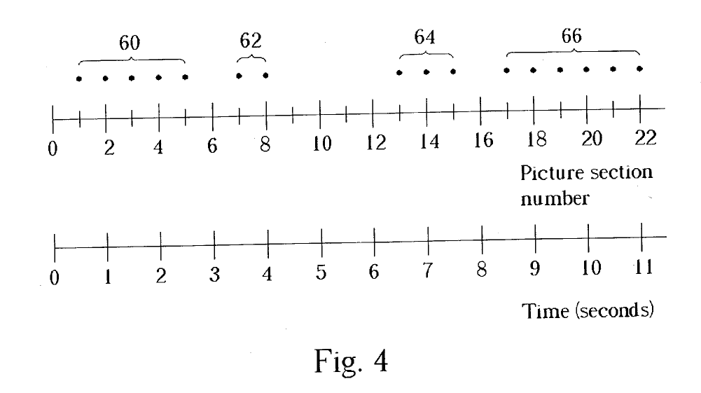

A structure of the present invention motion detection method is same as the prior art detecting system 50 shown in FIG. 1 and FIG. 2. The frame generator 20 is used to periodically picture a scene 52 according to a predetermined period to generate a plurality of image frames 22. The calculating device 30 is used to compare successive image frames to detect whether an object is moving inside the scene 52. When an object is moving, the calculating device 30 generates an event corresponding to the moving object. The event includes the image frames 22 associated with the moving objects. Please refer to FIG. 3 and FIG. 4. FIG. 3 is a flow chart of a first embodiment of the present invention motion detection method. FIG. 4 is a perspective view of the first embodiment of the present invention motion detection method. The procedures of the first embodiment of the present invention motion detection method are described as follows:

Step 100: Compare a duration of the event with a first threshold value, if the duration of the event is larger than the threshold value, execute step 102, otherwise, execute step 104;

Step 102: Determine that the event is valid, the detecting system 50 records the event; and

Step 104: Determine that the event is not valid, the detecting system 50 does not record the event.

An operation of the first embodiment of the present invention motion detection method is illustrated as follows. For easy illustration, the frame generator 20 of the first embodiment pictures two image frames each second. One horizontal axis in FIG. 4 represents time, and another axis represents picture section number of the image frame. A first threshold value is set to be 1.5 seconds. The frame generator 20 pictures the scene 52 and generates an image frame 22 every 0.5 seconds. The calculating device 30 compares the successive image frames 22. When the calculating device 30 compares the image frame 22 of picture section 2 with the image frame 22 of picture section 3, since the image frame 22 of picture section 2 is different from picture section 3, the calculating device 30 determines that an object is moving inside the scene 52 (according to the prior art detecting method). Therefore, the detecting system 50 detonates a first event 60. The first event 60 includes the image frames 22 of picture sections 2 and 3. Continuously, the calculating device 30 compares the image frame 22 of picture section 3 with picture section 4. Since the image frame 22 of picture section 4 is different from picture section 3, the calculating device 30 determines that the object is still moving. Therefore, the detecting system 50 continuously detonates the first event 60. Now, the first event 60 includes the image frames 22 of picture sections 2 to 4. Repeat the detecting operation above. When the calculating device 30 compares the image frame 22 of picture section 6 with picture section 5, since the object dose not move in picture section 6, the detecting system 50 stops to detonate the first event 60. Therefore, the first event 60 is detonated starting from the image frame 22 of picture section 2 and stopping at the image frame 22 of picture section 5. That means the first event 60 includes the image frames 22 of picture sections 2 to 5. Similarly, the calculating device 30 detonates a second event 62 that includes the image frames 22 of picture sections 7 and 8, a third event 64 includes the image frame 22 of picture sections 13 to 15, and a fourth event 66 that includes the image frames 22 of picture sections 1 7 to 22. The duration of the first event 60 is 2 seconds. The duration of the second event 62 is 0.5 seconds. The duration of the third event 64 is 1 second. The duration of the fourth event 66 is 2.5 seconds. Since the first threshold value is 1.5 seconds, the second event 62 and the third event 64 are ignored by the detecting system 50. The detecting system 50 does not record the second event 62 and the third event 64, and does not detonate any warning signal. Any event which has a duration less than the first threshold value is ignored by the detecting system 50. Users can adjust the first threshold value according to the detection demand in order to control the detecting system 50 to filter the unnecessary events. When a leaf is falling down or a passerby is passing before the door, the detecting system 50 ignores the event which has a duration less than the first threshold value set by users. Therefore, the detecting system 50 does not generate incorrect determinations.

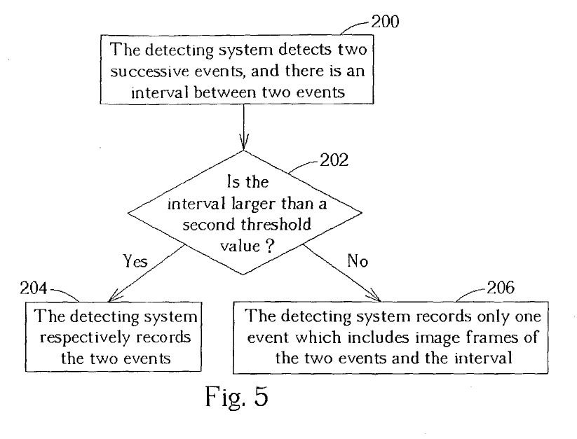

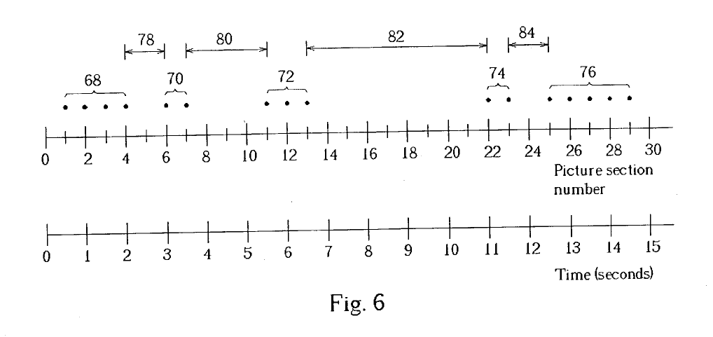

Please refer to FIG. 5 and FIG. 6. FIG. 5 is a flow chart of a second embodiment of the present invention motion detection method. FIG. 6 is a perspective view of the second embodiment of the present invention motion detection method. Procedures of the second embodiment of the present invention motion detection method are illustrated as follows:

Step 200: The detecting system 50 detects two successive events which includes a first event and a second event, an interval separates a termination of the first event and a beginning of the second event;

Step 202: Compare the interval with a second threshold value, if the interval is larger than the second threshold value, execute step 204, otherwise, execute step 206;

Step 204: Determine that the second event is not related to the first event, the detecting system 50 records both the first event and the second event; and

Step 206: Determine that the second event is related to the first event, the second event is merged into the first event, and the detecting system 50 only records the first event which includes image frames 22 generated within the durations of the first and second events and the interval between the first and second events.

An operation of the second embodiment of the present invention motion detection method is illustrated as follows. In the second embodiment, one horizontal axis represents time, and another horizontal axis represents a picture section number of the image frames 22. The second threshold value is 4 seconds. The frame generator 20 pictures the scene 52 to generate an image frame 22 every 0.5 seconds. As mentioned above, the calculating device 30 compares two successive image frames 22 so as to detect the moving object inside the scene 52 (according to the prior art detection method). The detecting system 50 detects a fifth event 68 which includes the image frames 22 of picture sections 1 to 4, a sixth event 70 which includes the image frames 22 of picture sections 6 and 7, a seventh event 72 which includes the image frames 22 of picture sections 11 to 13, a eighth event 74 which includes the image frames 22 of picture sections 22 and 23, and a ninth event 76 which includes the image frames 22 of picture sections 25 to 29. A first interval 78 between the fifth event 68 and the sixth event 70 is 1 second. Since the second threshold value is 4 seconds, the sixth event 70 is related to the fifth event 68 and the sixth event 70 is merged into the fifth event 68. That means the fifth event 68 includes the sixth event 70 and the fifth event 68 records the image frames 22 of picture sections 1 to 7. A second interval 80 between the sixth event 70 and the seventh event 72 is 1.5 seconds. The second interval 80 is less than the second threshold value. Therefore, the seventh event 72 is related to the sixth event 70 so that the seventh event 72 is merged into the fifth event 68. That means the fifth event 68 includes the sixth event 70 and the seventh event 72. The fifth event 68 records the image frames 22 of picture sections 1 to 13. A third interval 82 between the seventh event 72 and the eighth event 74 is 4.5 seconds. The third interval 82 is larger than the second threshold value so that the eighth event 74 is not related to the seventh event 72. The eighth event 74 is also not related to the fifth event 68. A fourth interval 84 between the eighth event 74 and the ninth event 76 is 1 second. The fourth interval 84 is less than the second threshold value so that the ninth event 76 is related to the eighth event 74. The ninth event 76 is merged into the eighth event 74. The eighth event 74 includes the ninth event 76 and records the image frames 22 of picture sections 22 to 29. As mentioned above, the detecting system 50 lastly obtains the fifth event 68 which includes the image frames 22 of picture sections 1 to 13, and the eighth event 74 which includes the image frames 22 of picture sections 22 to 29. Users can adjust the second threshold value according to the detection demand in order to control the detecting system 50 to filter the unnecessary events. When a dubious stranger walk-around inside the scene 52, the detecting system 50 can determine the relationship of the events according to the second threshold value set by users. Therefore, the detecting system 50 does not detect the incorrect detection.

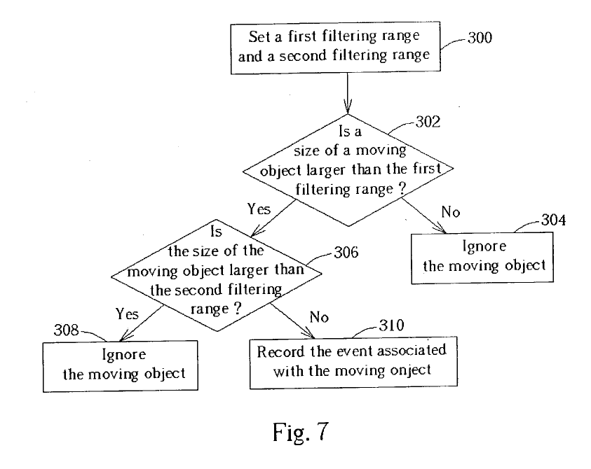

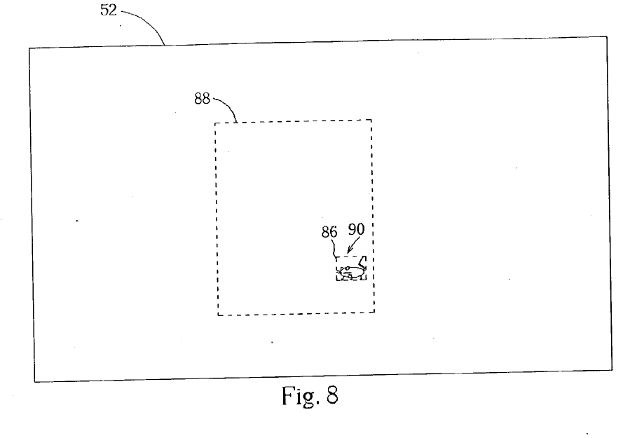

Please refer to FIG. 7 to FIG. 10. FIG. 7 is a flow chart of a third embodiment of the present invention motion detection method. FIG. 8 to FIG. 10 are perspective views of the third embodiment of the present invention motion detection method. Procedures of the third embodiment of the present invention motion detection method are illustrated as follows:

Step 300: Set a first filtering range and a second filtering range, in which the second filtering range is larger than the first filtering range;

Step 302: Compare a size of the moving object with the first filtering range, if the size of the moving object is larger than the first filtering range, execute step 306, otherwise, execute step 304;

Step 304: The detecting system 50 ignores the moving object and does not record the event associated with the moving object;

Step 306: Compare the size of the moving object with the second filtering range, if the size of the moving object is larger than the second filtering range, execute step 308, otherwise, execute step 310;

Step 308: The detecting system 50 ignores the moving object and does not record the event associated with the moving object; and

Step 310: The detecting system 50 records the event associated with the moving object.

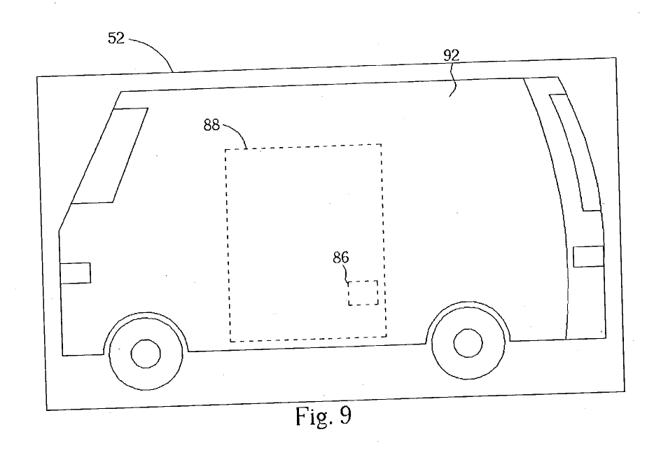

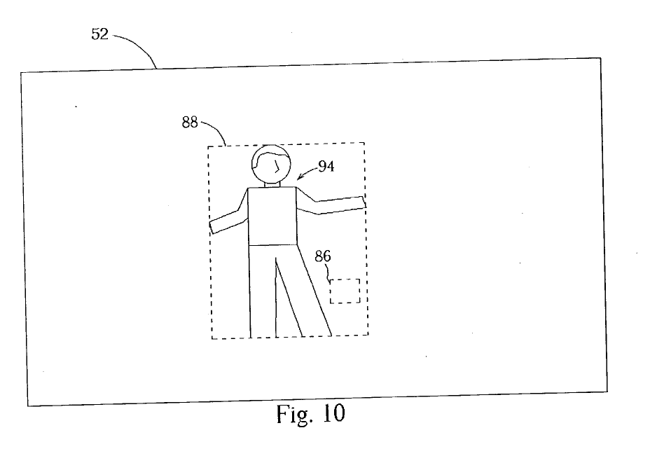

An operation of the third embodiment of the present invention motion detection method is illustrated as follows. In the third embodiment, users set the first filtering range 86 and the second filtering range 88. The second filtering range 88 is larger than the first filtering range 86. The second filtering range 88 is used to select large moving objects (such as a truck), and the first filtering range is used to select small moving object (such as a mouse). The first filtering range 86 and the second filtering range 88 can be rectangles, circles, or other polygons which are used to define a range. When a first moving object 90 (such as a mouse) appears inside the scene 52, as shown in FIG. 8, since a size of the first moving object 90 is smaller than the first filtering range 86, the detecting system 50 ignores the first moving object 90 and does not record the event associated with the first moving object 90 (step 304). When a second moving object 92 (such as a truck) appears inside the scene 52, as shown in FIG. 9, since a size of the second moving object 92 is larger than the first filtering range 86, the detecting system 50 continuously compares the size of the second moving object 92 with the second filtering range (step 306). The size of the second moving object 92 is also larger than the second filtering range 88, so that the detecting system 50 ignores the second moving object 92 and does not record the event associated with the second moving object 92 (step 308). However, when a third moving object 94 (such as a person) appears inside the scene 52, as shown in FIG. 10, since a size of the third moving object 94 is larger than the first filtering range 86, the detecting system 50 continuously compares the size of the third moving object 94 with the second filtering range (step 306). The size of the third moving object 94 is smaller than the second filtering range 88, so that the detecting system 50 records the event associated with the third moving object 94 (step 310). Users can adjust the first filtering range 86 and the second filtering range 88 according to detection demands so as to control the detecting system 50 to filter out unnecessary events. For example, users request the detecting system to generate the warning signal only when a dubious stranger walks around the door. Users can set the first filtering range 86 which is smaller than the size of a general human body, and set the second filtering range 88 which is larger than the size of a general human body. Therefore, the detecting system 50 can record the image frames 22 of all the moving objects which have sizes near that of the human body, according to the first filtering range 86 and the second filtering range 88, and also generate the corresponding warning signal. The detecting system 50 ignores the moving objects which have size less than the first filtering range 86 (such as a mouse) or larger than the second filtering range 88 (such as a truck) in order to avoid incorrect determinations. The third embodiment uses the first filtering range 86 and the second filtering range 88 to filter the unimportant moving objects and record the events associated with the important moving objects. Users also can picture the different moving object according to the different combinations of the first filtering range 86 and the second filtering range 88. For example, if users only use the first filtering range 86 to filter the moving object, the detecting system 50 can picture the moving objects which have size smaller than the first filtering range 86 or larger than the first filtering range 86. If users use the first filtering range 86 and the second filtering range 88 to filter the moving object, the detecting system 50 can picture the moving objects which have size between the first filtering range 86 and the second filtering range 88. If users only use the second filtering range 88 to filter the moving object, the detecting system 50 can picture the moving objects which have size larger than the second filtering range 88 or smaller than the second filtering range 88. Therefore, users can select the filtering range and the combination of the filtering range according to the detecting demand. Thus, users can select one or two of the moving objects 90, 92, 94, or all the moving objects 90, 92, 94 shown in FIG. 8 to FIG. 10. Moreover, the third embodiment can also choose the plurality of the combinations from the plurality of the filtering ranges so as to define the plurality of different filtering ranges. Therefore, the detecting system 50 can choose multiple moving objects which belong to different filtering range combinations.

All of the first, second, and third embodiments of the present invention motion detection method can prevent the detecting system 50 from generating incorrect determinations. The present invention motion detection method can combine two of the embodiments to detect the moving objects, or combine all of the embodiments to detect the moving objects so as to further prevent the detecting system 50 from generating the incorrect determinations.

In contrast to the prior art, the present invention motion detection method uses the first threshold value to filter events which have a short duration, uses the second threshold value to determine whether the two events are continuous so as to differentiate between the different events, and use two different filtering ranges to filter unimportant moving objects. Therefore, users can set and combine the first threshold value, the second threshold value, and the filtering ranges according to different detection demands. The present invention motion detection method satisfies the detection demands of users and also avoids the incorrect determinations.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A motion detection method used by a detecting system for detecting a plurality of moving objects moving inside a scene, the detecting system comprising:
a frame generator for periodically picturing the scene according to a predetermined period to generate a plurality of image frames; and
a calculating device for comparing successive image frames to detect the moving objects inside the scene and to generate an event corresponding to the moving objects, the event comprising image frames associated with the moving objects;
the motion detection method comprising:
comparing a duration of the event with a first threshold value to determine whether the event is valid.

2. The motion detection method of claim 1 wherein if the duration of the event is longer than the first threshold value, the event is valid and is recorded by the detecting system; otherwise, the event is not valid and is not recorded by the detecting system.

3. The motion detection method of claim 1 wherein the detecting system detects a plurality of successful events which comprises a first event and a second event, the first event is generated prior to the second event, and there is an interval between a termination of the first event and a beginning of the second event; the motion detection method further comprising:
comparing the interval with a second threshold value to determine whether the second event is related to the first event for merging the second event into the first event.

4. The motion detection method of claim 3 wherein if the interval is shorter than the second threshold value, the second event is merged into the first event, and the detecting system only records the first event, which includes image frames generated within the durations of the first and second events and the interval between the first and second events, and if the interval is longer than the second threshold value, the second event is not related to the first event, and the detecting system records both the first event and the second event.

5. The motion detection method of claim 1 further comprising:
setting at least a filtering range; and
comparing a size of the moving objects with the filtering range to determine whether the detecting system records an event associated with the moving objects.

6. The motion detection method of claim 5 wherein if the size of the moving objects is larger than the filtering range, the detecting system ignores the moving objects without recording the event associated with the moving objects.

7. The motion detection method of claim 5 wherein if the size of the moving objects is smaller than the filtering range, the detecting system ignores the moving objects without recording the event associated with the moving objects.

8. The motion detection method of claim 5 wherein the filtering range is a rectangle.

9. A motion detection method used by a detecting system for detecting moving objects moving inside a scene, the detecting system comprising:
a frame generator for periodically picturing the scene according to a predetermined period and generating a plurality of image frames; and
a calculating device for comparing successive image frames to detect the moving objects inside the scene and to generate an event corresponding to the moving objects, the event comprising image frames associated with the moving objects;
the motion detection method comprising:
detecting a plurality of successful events which comprises a first event and a second event, the first event being generated prior to the second event, an interval separating a termination of the first event and a beginning of the second even; and
comparing the interval with a second threshold value to determine whether the second event is related to the first event for merging the second event into the first event.

10. The motion detection method of claim 9 wherein if the interval is shorter than the second threshold value, the second event is merged into the first event, and the detecting system only records the first event, which includes image frames generated within the durations of the first and second events and the interval between the first and second events, and if the interval is longer than the second threshold value, the second event is not related to the first event, and the detecting system records both the first event and the second event.

11. The motion detection method of claim 9 further comprising: comparing a duration of the event with a first threshold value to determine whether the event is valid.

12. The motion detection method of claim 11 wherein if the duration of the event is longer than the first threshold value, the event is valid and is recorded by the detecting system; otherwise, the event is not valid and is not recorded by the detecting system.

13. The motion detection method of claim 9 further comprising:
setting at least a filtering range; and
comparing a size of the moving objects with the filtering range to determine whether the detecting system records an event associated with the moving objects.

14. The motion detection method of claim 13 wherein if the size of the moving objects is larger than the filtering range, the detecting system ignores the moving objects without recording the event associated with the moving objects.

15. The motion detection method of claim 13 wherein if the size of the moving objects is smaller than the filtering range, the detecting system ignores the moving objects without recording the event associated with the moving objects.

16. The motion detection method of claim 13 wherein the filtering range is a rectangle.

17. A motion detection method used by a detecting system for detecting moving objects moving inside a scene, the detecting system comprising:
a frame generator for periodically picturing the scene according to a predetermined period to generate a plurality of image frames; and
a calculating device for comparing successive image frames to detect the moving objects inside the scene and to generate an event corresponding to the moving objects, the event comprising image frames associated with the moving objects;
the motion detection method comprising:
setting at least a filtering range; and
comparing a size of the moving objects with the filtering range to determine whether the detecting system records an event associated with the moving objects.

18. The motion detection method of claim 17 wherein if the size of the moving objects is larger than the filtering range, the detecting system ignores the moving objects without recording the event associated with the moving objects.

19. The motion detection method of claim 17 wherein if the size of the moving objects is smaller than the filtering range, the detecting system ignores the moving objects without recording the event associated with the moving objects.

20. The motion detection method of claim 17 wherein the filtering range is a rectangle.

21. The motion detection method of claim 17 further comprising: comparing a duration of the event with a first threshold value to determine whether the event is valid.

22. The motion detection method of claim 22 wherein if the duration of the event is longer than the first threshold value, the event is valid and is recorded by the detecting system; otherwise, the event is not valid and is not recorded by the detecting system.

23. The motion detection method of claim 17 wherein the detecting system detects a plurality of successful events which comprises a first event and a second event, the first event is generated prior to the second event, and there is an interval between a termination of the first event and a beginning of the second event; the motion detection method further comprising:
comparing the interval with a second threshold value to determine whether the second event is related to the first event for merging the second event into the first event.

24. The motion detection method of claim 23 wherein if the interval is shorter than the second threshold value, the second event is merged into the first event, and the detecting system only records the first event, which includes image frames generated within the durations of the first and second events and the interval between the first and second events, and if the interval is longer than the second threshold value, the second event is not related to the first event, and the detecting system records both the first event and the second event.
